(19) United States
(12) Patent Application Publication
(10) Pub. No.: US 2026/0143502 A1
(43) Pub. Date: May 21, 2026

(54) PHYSICAL DOWNLINK CONTROL CHANNEL TRANSMISSION CONFIGURATIONS

(71) Applicant: QUALCOMM Incorporated, San Diego, CA (US)

(72) Inventors: Javier RODRIGUEZ FERNANDEZ, San Diego, CA (US); Kazuki TAKEDA, Tokyo (JP); Kianoush HOSSEINI, San Diego, CA (US)

(21) Appl. No.: 18/948,813

(22) Filed: Nov. 15, 2024

(51) Int. Cl. H04W 72/232

(52) U.S. Cl. CPC H04W 72/232

(57) ABSTRACT

Various aspects of the present disclosure generally relate to wireless communication. In some aspects, a user equipment (UE) may receive a configuration for a physical downlink control channel (PDCCH) transmission indicating a set of PDCCH candidates that spans a plurality of multiple-input multiple-output (MIMO) layers associated with a single transmission reception point (TRP). The UE may monitor for control information in the set of PDCCH candidates in accordance with the configuration. The UE may decode the control information identified within at least one PDCCH candidate of the set of PDCCH candidates. Numerous other aspects are described.

### FIELD OF THE DISCLOSURE

Aspects of the present disclosure generally relate to wireless communication and specifically relate to techniques, apparatuses, and methods associated with physical downlink control channel (PDCCH) transmission configurations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving a configuration for a physical downlink control channel (PDCCH) transmission indicating a set of PDCCH candidates that spans a plurality of multiple-input multiple-output (MIMO) layers associated with a single transmission reception point (TRP). The method may include monitoring for control information in the set of PDCCH candidates in accordance with the configuration. The method may include decoding the control information identified within at least one PDCCH candidate of the set of PDCCH candidates.

Some aspects described herein relate to an apparatus for wireless communication at a UE. The apparatus may include one or more memories and one or more processors coupled to the one or more memories. The one or more processors may be configured to receive a configuration for a PDCCH transmission indicating a set of PDCCH candidates that spans a plurality of MIMO layers associated with a single TRP. The one or more processors may be configured to monitor for control information in the set of PDCCH candidates in accordance with the configuration. The one or more processors may be configured to decode the control information identified within at least one PDCCH candidate of the set of PDCCH candidates.

Some aspects described herein relate to a non-transitory computer-readable medium that stores a set of instructions for wireless communication by a UE. The set of instructions, when executed by one or more processors of the UE, may cause the UE to receive a configuration for a PDCCH transmission indicating a set of PDCCH candidates that spans a plurality of MIMO layers associated with a single TRP. The set of instructions, when executed by one or more processors of the UE, may cause the UE to monitor for control information in the set of PDCCH candidates in accordance with the configuration. The set of instructions, when executed by one or more processors of the UE, may cause the UE to decode the control information identified within at least one PDCCH candidate of the set of PDCCH candidates.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example wireless communication network, in accordance with the present disclosure.

FIG. 4 is a diagram illustrating an example process, in accordance with the present disclosure.

FIGS. 5A, 5B, and 5C are diagrams illustrating example configurations for PDCCH transmissions, in accordance with the present disclosure.

FIG. 6 is a diagram illustrating an example process performed, for example, at a UE or an apparatus of a UE, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, wireless communication devices (such as user equipments (UEs) and network nodes) may communicate via single-input single-output (SISO) communications or multi-input multi-output (MIMO) communications. For SISO communications, a transmitting wireless communication device may transmit a wireless signal to a receiving wireless communication device using a single antenna (or a single antenna element), and the wireless signal may include a single data stream (e.g., a single transmission layer). For MIMO communications, the transmitting wireless communication device may transmit a wireless signal using more than one antenna (or more than one antenna element), and the wireless signal may include more than one data stream (e.g., more than one layer, more than one MIMO layer). The use of SISO communications versus MIMO communications may depend on a variety of operating factors, such as requested data rates, data transfer latency operating conditions, implementation costs, network access demand, and a capability of the transmitting and receiving wireless communication devices. SISO communications may provide a cost-effective solution for areas that have low network access demand, while MIMO communications may provide higher data throughput and/or lower data transfer latencies relative to SISO communications.

In some wireless communication networks, a wireless communication device may use MIMO communications for initial access (e.g., for synchronization signal block (SSB) transmissions), uplink data transmissions (e.g., via a physical uplink shared channel (PUSCH), or downlink data transmissions (e.g., via a physical downlink shared channel (PDSCH)). But these wireless communication networks may not support a single transmitting wireless communication device using MIMO communications for control channel transmissions (e.g., for physical downlink control channel (PDCCH) transmissions or for physical uplink control channel (PUCCH) transmissions). In some cases, multiple transmission reception points (TRPs) may coordinate a MIMO PDCCH transmission from the multiple TRPs. For example, two network nodes (e.g., via two corresponding TRPs) may configure two control resource sets that each schedule repeated downlink control information (DCI) to achieve the spatial diversity gain associated with MIMO transmissions. Here, the PDCCH transmission may correspond to a multi-cell MIMO transmission (e.g., a multi-user MIMO (MU-MIMO) transmission), where two single layer transmissions from two network nodes or from two TRPs are received and decoded by a receiving wireless communication device as a two layer PDCCH transmission. But coordinating the multiple network nodes or TRPs to provide the multi-cell MIMO PDCCH transmission may introduce latency and increased signaling overhead for the PDCCH transmission.

In wireless communication networks described herein, a single network node may be capable of transmitting MIMO PDCCH transmissions (e.g., using a single TRP to transmit a single-user MIMO (SU-MIMO) transmission). MIMO PDCCH transmissions may be associated with increased resource utilization efficiency (e.g., by increasing a quantity of available control channel elements (CCEs)), reduced latency associated with scheduling PDSCH and PUSCH transmissions (e.g., especially for serving cells that are serving a large quantity of wireless communication devices), and reduced likelihood of blockage (e.g., by increasing the spatial diversity of PDCCH transmissions) as compared to SISO PDCCH transmissions. Additionally, by transmitting the MIMO PDCCH transmissions via a single TRP, the signaling overhead and latency associated with MU-MIMO PDCCH transmissions may be reduced. Additionally, some wireless communication devices may not be capable of receiving or decoding MIMO PDCCH transmissions. Accordingly, the network node may transmit both MIMO and SISO PDCCH transmissions.

To configure such PDCCH transmissions, the network node may transmit, and a UE may receive, configuration information indicating a configuration for receiving either a MIMO or SISO PDCCH transmission (or in some cases, a configuration for receiving both a MIMO and a SISO PDCCH transmission). The configuration may indicate whether the UE is monitoring one or more MIMO PDCCH candidates or one or more SISO PDCCH candidates. Particular aspects of the subject matter described in this disclosure can be implemented to realize one or more of the following potential advantages. In some examples, the described techniques can be used to dynamically configure UEs to receive either MIMO or SISO PDCCH transmissions, which may enable the network node to dynamically configure MIMO or SISO PDCCH transmissions based on requested data rates, data transfer latency operating conditions, implementation costs, network access demand, and a capability of the transmitting and receiving wireless communication devices. Additionally, the described techniques may enable a network node to transmit PDCCH communications to both UEs that are capable of supporting MIMO PDCCH transmissions and UEs that are not capable of supporting MIMO PDCCH transmissions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

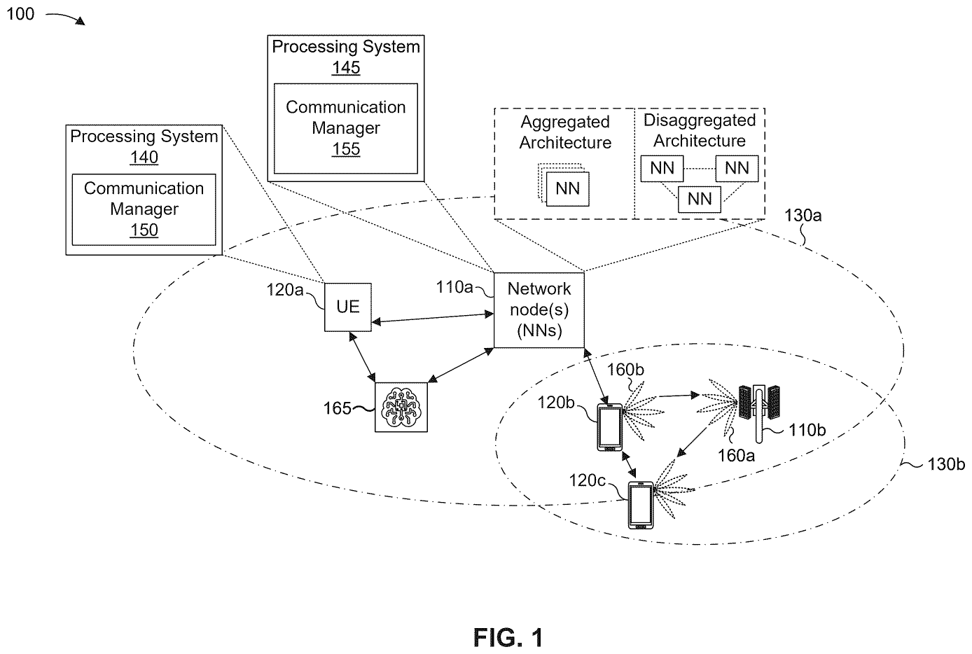

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting wireless communication device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a TRP, a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

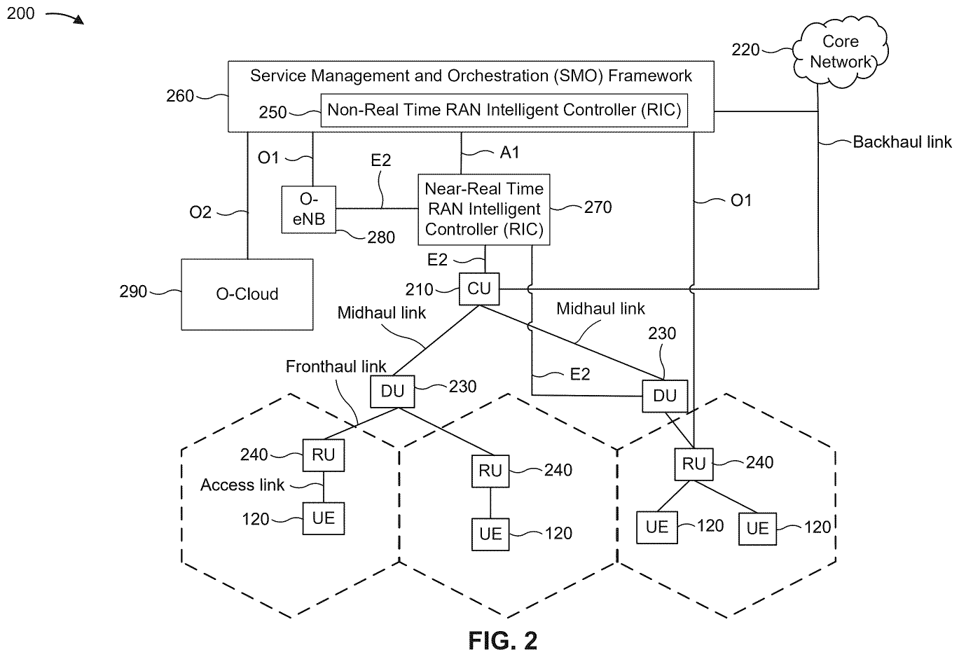

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and CCEs), and spatial domain resources (for example, particular transmit directions or beams).

Frequency domain resources may be subdivided into bandwidth parts (BWPs). A BWP may be a block of frequency domain resources (for example, a continuous set of resource blocks within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to DCI from a network node 110 to a UE 120. DCI generally contains the information the UE 120 needs to identify resource blocks in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more transport blocks of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation (e.g., spatial diversity). A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving wireless communication device or otherwise in a desired direction, a directional reception of a wireless signal from a transmitting wireless communication device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as MU-MIMO. Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT). In some other examples, MIMO may support simultaneous transmission from a single transmitter and to a single receiver, referred to as SU-MIMO. Here, a single TRP may rely on spatial diversity to transmit multiple layers of the SU-MIMO transmission to a single receiver.

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing. For example, a transmitting wireless communication device (e.g., a network node 110) may use multiple antenna elements on a single TRP to support SU-MIMO transmissions. Here, the network node 110 may transmit a first layer of the MIMO transmission using a first set of one or more antenna elements of the TRP and may transmit a second layer of the MIMO transmission using a second set of one or more antenna elements of the TRP.

In the wireless communication network 100, a single network node 110 may be capable of transmitting MIMO PDCCH transmissions (e.g., using a single TRP to transmit a SU-MIMO transmission). MIMO PDCCH transmissions may be associated with increased resource utilization efficiency, reduced latency associated with scheduling PDSCH and PUSCH transmissions, and reduced likelihood of blockage as compared to SISO PDCCH transmissions. Additionally, by transmitting the MIMO PDCCH transmissions via a single TRP, the signaling overhead and latency associated with MU-MIMO PDCCH transmissions may be reduced. Additionally, some wireless communication devices may not be capable of receiving or decoding MIMO PDCCH transmissions. Accordingly, the network node 110 may transmit both MIMO and SISO PDCCH transmissions. To configure such PDCCH transmissions, the network node 110 may transmit, and a UE 120 may receive, configuration information indicating a configuration for receiving either a MIMO or SISO PDCCH transmission (or in some cases, a configuration for receiving both a MIMO and a SISO PDCCH transmission). The configuration may indicate whether the UE 120 is monitoring one or more MIMO PDCCH candidates or one or more SISO PDCCH candidates.

In some aspects, the UE 120 may include a communication manager 150. As described in more detail elsewhere herein, the communication manager 150 may receive a configuration for a PDCCH transmission indicating a set of PDCCH candidates that spans a plurality of MIMO layers associated with a single TRP; monitor for control information in the set of PDCCH candidates in accordance with the configuration; and decode the control information identified within at least one PDCCH candidate of the set of PDCCH candidates. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

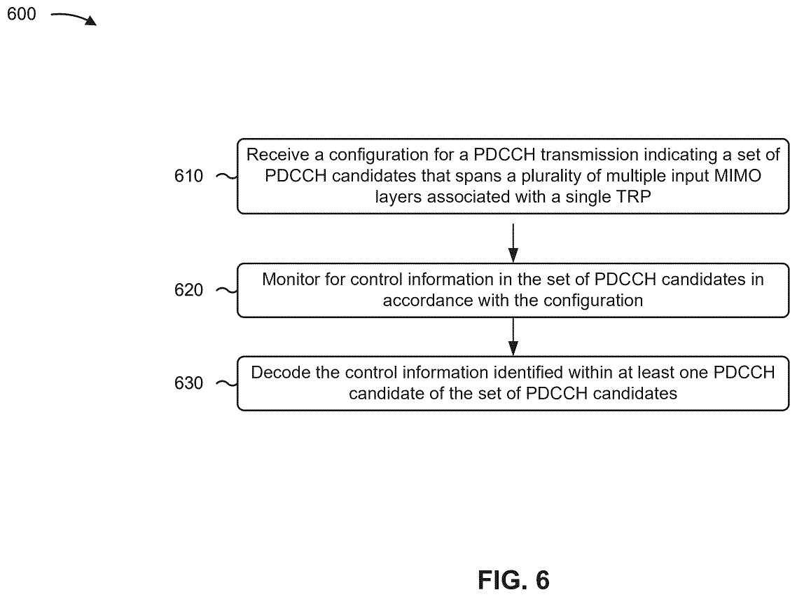

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with PDCCH transmission configurations, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, or other processes as described herein. In some examples, executing instructions may include running the instructions, converting the instructions, compiling the instructions, and/or interpreting the instructions, among other examples.

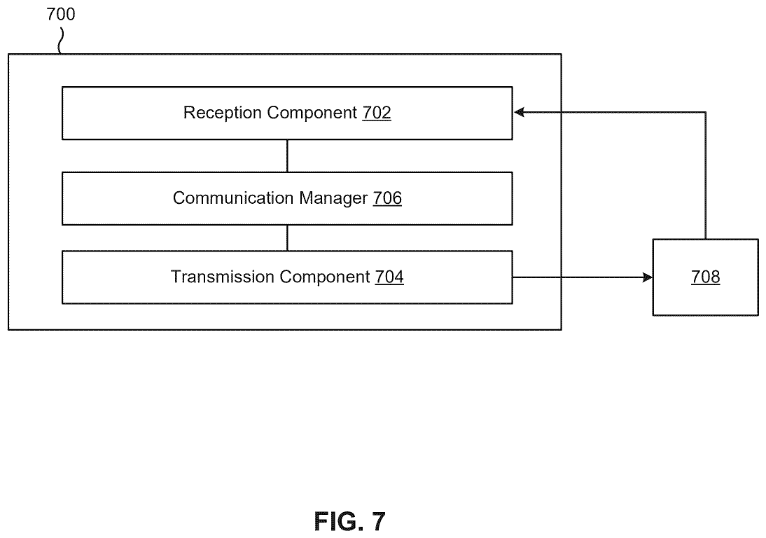

In some aspects, the UE includes means for receiving a configuration for a PDCCH transmission indicating a set of PDCCH candidates that spans a plurality of MIMO layers associated with a single TRP; means for monitoring for control information in the set of PDCCH candidates in accordance with the configuration; and/or means for decoding the control information identified within at least one PDCCH candidate of the set of PDCCH candidates. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

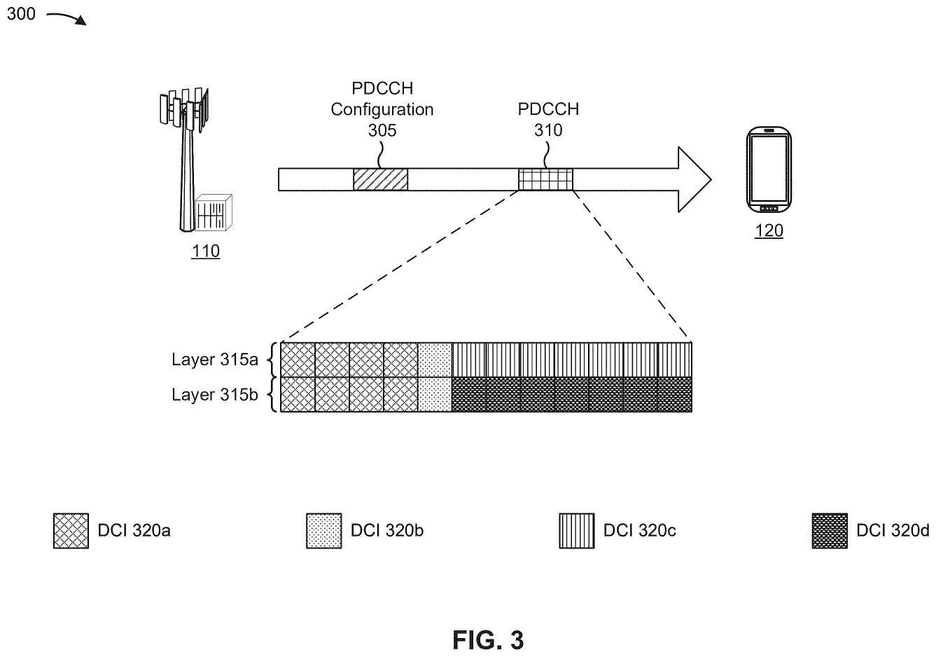

FIG. 3 is a diagram illustrating an example wireless communication network 300, in accordance with the present disclosure. As shown in FIG. 3, a network node 110 and a UE 120 may communicate with one another. For example, the network node 110 may transmit DCI 320 to the UE 120 via a MIMO transmission in the PDCCH 310.

The PDCCH 310 may include multiple sets of DCI 320. For example, the PDCCH 310 may include a first set of DCI 320a, a second set of DCI 320b, a third set of DCI 320c, and a fourth set of DCI 320d. The network node 110 may transmit the DCI 320 via a first layer 315a, a second layer 315b, or both the first layer 315 and the second layer 315b. The layers 315 may correspond to layers of communication, and transmissions sent over the different layers 315 may be associated with different propagation (or spatial) paths. Accordingly, the network node 110 may transmit multiple data streams via overlapping time and frequency resources using the spatial diversity supported by the multiple layers 315.

In some cases, the DCI 320 that is transmitted via a single layer 315 (such as the DCI 320c and the DCI 320d) may correspond to a SISO transmission in the PDCCH 310 (e.g., a SISO PDCCH transmission). Additionally, the DCI 320 that is transmitted via more than one layer 315 (such as the DCI 320a and the DCI 320b) may correspond to a MIMO transmission in the PDCCH 310 (e.g., to a MIMO PDCCH transmission). In the wireless communication network 300, the network node 110 may be configured to transmit both two-layer PDCCH transmissions (e.g., the DCI 320a and the DCI 320b) and single layer PDCCH transmissions (e.g., the DCI 320c and the DCI 320d). That is, the two-layer PDCCH candidates and transmissions effectively and efficiently coexist with single layer PDCCH candidates and transmissions. In some cases, enabling MIMO PDCCH transmissions may be based on the PDCCH configuration 305. For example, a two-layer transmission of UE-specific one-layer DCI 320 may increase a control resource set efficiency, but may cause an increase in layer signaling and an increase in signal processing at the modem (e.g., of the UE 120, of the network node 110).

In some cases, there may be different configurations for space-frequency locations of the PDCCH candidates (e.g., there may be several degrees of freedom in terms of the space-frequency localization of PDCCH candidates). The various configurations may be associated with different flexibility, efficiencies, RF and MIMO processing at a modem of the network node 110 and UE 120. For example, one configuration may be a localized or distributed space-frequency configuration for multi-DCI transmissions, which may be associated with an increased throughput as compared to other configurations. In another example, a configuration may be a localized or distributed space-frequency configuration for a layer-split DCI transmission, which may be associated with an increased efficiency as compared to other configurations. Additionally, or alternatively, a localized CCE mapping configuration (e.g., where the CCEs for a set of PDCCH candidates include a same set of time and frequency CCEs in the different layers 315) may be associated with a greater RF and MIMO processing impact, but a decreased frequency diversity as compared to other configurations. Further, a distributed CCE mapping configuration (e.g., where the CCEs for a set of PDCCH candidates include different sets of time or frequency CCEs in the different layers 315) may be associated with less RF and MIMO processing impacts, but increased frequency diversity as compared to other configurations.

In the wireless communication network 300, the network node 110 may transmit, and the UE 120 may receive, signaling indicating a PDCCH configuration 305 for the subsequent PDCCH 310. The PDCCH configuration 305 may indicate, to the UE 120, whether the UE 120 is to monitor one or more MIMO or SISO PDCCH candidates. That is, the PDCCH configuration 305 may indicate a set of PDCCH candidates for the UE 120 to monitor to receive and decode the DCI 320. If the set of PDCCH candidates that include the DCI 320 for the UE 120 span both of the layers 315, the PDCCH configuration 305 may indicate for the UE 120 to monitor one or more MIMO PDCCH candidates. Additionally, if the set of PDCCH candidates that include the DCI 320 for the UE 120 are contained within a single layer 315, the PDCCH configuration 305 may indicate for the UE 120 to monitor one or more SISO PDCCH candidates.

In an example where the DCI 320a includes control information for the UE 120, the PDCCH configuration 305 may indicate the set of PDCCH candidates that carry the DCI 320a and span the first layer 315a and the second layer 315b. In another example where the DCI 320c includes the control information for the UE 120, the PDCCH configuration 305 may indicate the set of PDCCH candidates that carry the DCI 320c and that are within the single layer 315a.

The PDCCH configuration 305 may additionally indicate one or more spatial parameters associated with the UE 120 receiving and decoding the DCI 320 within the PDCCH 310. In particular, if the PDCCH configuration 305 indicates for the UE 120 to monitor a set of MIMO PDCCH candidates, the PDCCH configuration 305 may additionally indicate the one or more spatial parameters. For example, the PDCCH configuration 305 may indicate a quantity of layers associated with the set of MIMO PDCCH candidates, a precoding type associated with the set of PDCCH candidates.

The UE 120 may monitor the set of PDCCH candidates that carry the DCI 320 for the UE 120 in accordance with the PDCCH configuration 305. Based on monitoring the set of PDCCH candidates, the UE 120 may attempt to receive and decode the DCI 320 carried within one or more of the PDCCH candidates within the set of PDCCH candidates.

As indicated above, FIG. 3 is provided as an example. Other examples may differ from what is described with respect to FIG. 3.

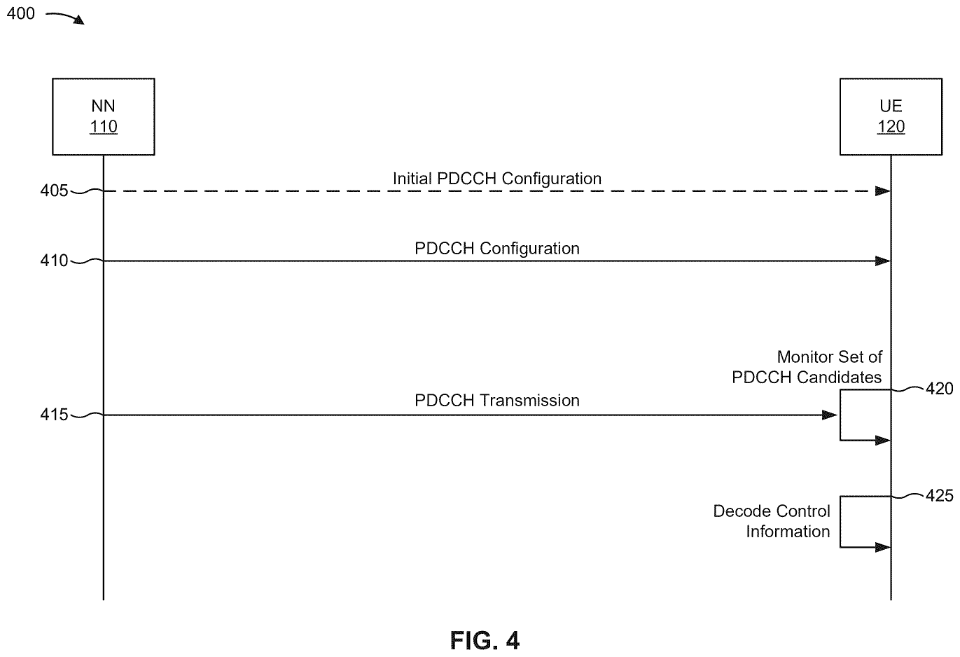

FIG. 4 is a diagram illustrating an example process 400, in accordance with the present disclosure. As shown in FIG. 4, a network node 110 and a UE 120 may communicate with one another. For example, the process 400 may illustrate communications exchanged between the network node 110 and the UE 120 to configure a SU-MIMO PDCCH transmission from the network node 110 to the UE 120. In some cases, the network node 110 and the UE 120 in the wireless communication network 300 (e.g., as described with reference to FIG. 3) may implement aspects of the process 400.

As shown by reference number 405, the network node 110 may optionally transmit, and the UE 120 may receive, an initial PDCCH configuration. Additionally, and as shown by reference number 410, the network node 110 may transmit, and the UE 120 may receive, a PDCCH configuration. When the network node 110 does transmit the initial PDCCH configuration, the PDCCH configuration may indicate one or more updates for the UE 120 to make to the initial configuration. The PDCCH configuration may indicate a configuration for a MIMO PDCCH transmission and may indicate a set of PDCCH candidates that span a set of MIMO layers associated with a single TRP of the network node 110. The set of PDCCH candidates may correspond to a search space set and may be associated with a control resource set. The PDCCH configuration may additionally indicate one or more PDCCH candidate indices and an aggregation level associated with the PDCCH transmission. The UE 120 may use the indicated one or more PDCCH candidate indices and the aggregation level to identify the set of PDCCH candidates and avoid performing multiple blind decoding operations to identify the one or more PDCCH candidates that include the PDCCH transmission. The PDCCH configuration may additionally indicate co-scheduling information associated with the PDCCH transmission. In particular, the PDCCH configuration may indicate whether some ports associated with the PDCCH transmission are co-scheduled based on an aggregation level of the PDCCH transmission (e.g., the network node 110 may indicate the co-scheduling information for certain aggregation levels). The network node 110 may indicate the co-scheduling information using MAC-CE signaling or DCI signaling. Additionally, in some cases the network node 110 may not provide any indication of the co-scheduling information to the UE 120.

Additionally, the PDCCH configuration may indicate one or more ports associated with the PDCCH transmission, one or more DMRS configurations associated with the PDCCH transmission, or both (e.g., similar to a MIMO indication for PDSCH in a DCI format 1_1). In one case, the network node 110 may indicate the one or more ports associated with the PDCCH transmission based on a predefined port set. For example, each search space may be associated with a predefined set of ports. Here, the PDCCH configuration may indicate the one or more ports based on a search space identifier. In another case, the network node 110 may indicate the one or more ports associated with the PDCCH transmission using a dynamic MAC-CE command. Here, the MAC-CE command may activate a state corresponding to the PDCCH reception with the combination of indicated ports. In another case, the network node 110 may indicate the one or more ports associated with the PDCCH transmission using DCI signaling (e.g., via a dynamic DCI indication). Here, the network node 110 may transmit DCI to the UE 120 that indicates the one or more ports associated with the PDCCH transmission (which may be similar to a MIMO indication for PDSCH in the DCI format 1_1). In another case, the network node 110 may not provide an indication of the one or more ports associated with the PDCCH transmission. Here, the UE 120 may perform one or more blind decoding operations to hypothesize the one or more ports and a DMRS configuration associated with the set of PDCCH candidates (e.g., that are carrying the PDCCH transmission for the UE 120).

The network node 110 may transmit, and the UE 120 may receive, the PDCCH configuration to the UE 120 (e.g., at 410) using RRC signaling. In some cases, the PDCCH configuration indicated by the RRC signaling may indicate a spatial configuration for a PDCCH transmission. In some cases, the spatial configuration may be associated with or configured for a search space (e.g., via a searchSpace information element within the RRC signaling) or associated with or configured for a control resource set (e.g., via a ControlResourceSet information element within the RRC signaling). The RRC signaling may indicate a common search space (e.g., for multiple UEs including at least the UE 120), a UE-specific search space (e.g., a search space that is specific to the UE 120), or both a common search space and a UE-specific search space. The RRC signaling may include a spatial configuration information element (e.g., a spatialConfig information element, a spatialCCEConfig information element) that indicates a precoding type associated with the PDCCH transmission (e.g., a precoder-cycling or open loop precoder, SRS-based single value decomposition for time domain duplexing), a quantity of layers associated with the PDCCH transmission, one or more indices indicative of a set of CCEs for the MIMO PDCCH candidates, or a combination thereof.

In one example where the PDCCH configuration is indicated by RRC signaling, the PDCCH configuration may be associated with a DCI format of the PDCCH transmission. That is, the RRC signaling may indicate, for PDCCH transmissions having the DCI format, the PDCCH configuration via a search space set associated with the PDCCH transmission, a control resource set associated with the PDCCH transmission, or both. Additionally, the PDCCH configuration may indicate, for the PDCCH transmissions having the DCI format, whether the PDCCH transmission is a MIMO PDCCH transmission or a SISO PDCCH transmission and a quantity of PDCCH candidates in the set that the UE 120 is to monitor based on a quantity of MIMO layers. For example, the RRC signaling may include a spatial configuration information element (e.g., a spatialConfig information element) within an information element associated with a control resource set for the PDCCH configuration (e.g., a searchSpaceControlResourceSet information element) that is configured on a per-DCI format basis. The spatial configuration information element may indicate a quantity of PDCCH candidates that the UE 120 is to monitor for a given quantity of layers. Accordingly, the network node 110 may configure the spatial configuration (e.g., and whether the corresponding PDCCH transmission is a MIMO PDCCH transmission or a SISO PDCCH transmission) on a per-DCI format basis. In some cases, the network node 110 may adjust the PDCCH configuration based on network conditions and a minimum required capability associated with the PDCCH configuration (and based on the capability of the UE 120).

In another example where the PDCCH configuration is indicated by RRC signaling, the RRC signaling may configure the PDCCH configuration as a MIMO-specific PDCCH configuration. For example, the RRC signaling may configure a MIMO search space set, a MIMO control resource set, or both. Additionally, the RRC signaling may indicate that the MIMO search space set and/or the MIMO control resource set includes the set of PDCCH candidates. For example, the network node 110 may transmit a spatial configuration information element (e.g., a spatialConfig information element) within an information element associated with a control resource set for MIMO PDCCH transmissions (e.g., a searchSpaceControlResourceSet information element that is for MIMO) that indicates the spatial configuration for MIMO PDCCH transmissions. In this example, the RRC signaling may also configure one or more SISO-specific parameters. For example, the RRC signaling may configure a SISO search space set (e.g., including a set of SISO PDCCH candidates), a SISO control resource set, or both. That is, the network node 110 may also transmit a spatial configuration information element within an information element associated with a control resource set for SISO PDCCH transmissions. Here, the SISO PDCCH candidates may overlap with the MIMO PDCCH candidates fully, partially, or not at all in the frequency domain.

In another example where the PDCCH configuration is indicated by RRC signaling, the PDCCH configuration may be associated with a MIMO-specific DCI format of the PDCCH transmission. That is, the RRC signaling may indicate a configuration for DCI transmissions having a MIMO-specific DCI format (e.g., a MIMO DCI format 1_0, a MIMO DCI format 0_0). Here, the RRC signaling may indicate, for PDCCH transmissions having the MIMO DCI format, a quantity of PDCCH candidates in the set that the UE 120 is to monitor based on the quantity of MIMO layers that the set of PDCCH candidates spans. The RRC signaling may additionally indicate a spatial configuration for the PDCCH transmissions having the MIMO DCI format (e.g., via a searchSpace information element included in a spatialConfig information element).

In another example where the PDCCH configuration is indicated by RRC signaling, the RRC signaling may indicate a set of CCEs that are associated with MIMO PDCCH candidates. Additionally, the set of PDCCH candidates indicated in the PDCCH configuration (e.g., as carrying control information for the UE 120) may include CCEs from the set of CCEs that are indicated as being associated with the MIMO PDCCH candidates. For example, the PDCCH configuration may indicate one or more CCEs or one or more groups or sets of CCEs that are associated with MIMO PDCCH candidates (e.g., via a spatialCCEConfig information element within a searchSpaceControlResourceSet information element). The RRC signaling may indicate which CCEs are reserved for MIMO PDCCH candidates as an explicit list of CCEs or an explicit list of groups of CCEs or using an index or set of indices that indicate one or more CCEs within a predefined table. For example, the index or indices may indicate one or more entries within the predefined table that indicate one or more CCEs that are reserved for MIMO PDCCH candidates.

In some other cases, the network node 110 may transmit, and the UE 120 may receive, the PDCCH configuration to the UE 120 (e.g., at 410) using one or more MAC-CE commands. The MAC-CE commands may correspond to MAC-CE activation commands that indicate, to the UE 120, that the set of PDCCH candidates have the MIMO configuration. In some cases, the network node 110 may transmit the MAC-CE command to the UE 120 in response to channel measurements. For example, the UE 120 may transmit, and the network node 110 may receive, signaling indicative of a channel condition associated with the UE 120. That is, the UE 120 may transmit an SRS or PUCCH feedback to the network node 110. Then, based on one or more channel measurements associated with the signaling, the network node 110 may transmit the MAC-CE activation command.

In one example where the network node 110 transmits the PDCCH configuration to the UE 120 via a MAC-CE command, the UE 120 may have several TCI states that each correspond to a MIMO-only configuration, and the MAC-CE command may activate the PDCCH configuration. For example, the UE 120 may have a two port transmission with a two port variant of precoder cycling MIMO TCI state, a two port transmission with SRS or feedback or codebook-based precoder cycling MIMO TCI state, or some other MIMO TCI state. Here, the MAC-CE activation command may indicate for the UE 120 to receive an M-layer PDCCH transmission using a precoder type (e.g., associated with one of the MIMO TCI states that the UE 120 has). That is, the MAC-CE activation command may indicate that the PDCCH candidates within the set of PDCCH candidates for a corresponding component carrier or bandwidth part may span the M layers, and PDCCH transmissions within the PDCCH candidates may be transmitted with a precoder that is associated with a specific MIMO TCI state. In some cases, the MAC-CE command may apply to certain aggregation or puncturing levels. Here, the MAC-CE command may indicate an aggregation or puncturing level associated with the PDCCH transmission.

In some examples where the network node 110 transmits the PDCCH configuration to the UE 120 via the MAC-CE activation command, the MAC-CE activation command may override a previously-configured PDCCH configuration (e.g., an RRC PDCCH configuration). For example, at 405 the network node 110 may indicate the initial PDCCH configuration via RRC signaling, and at 410 the network node 110 may transmit the MAC-CE activation command to indicate the PDCCH configuration that overrides the initial PDCCH configuration. In some cases, the network node 110 may override a spatial RRC PDCCH configuration for a search space set or a control resource set (e.g., via the MAC-CE activation command) in response to a change in one or more channel conditions. For example, an initial spatial RRC PDCCH configuration may configure a set of PDCCH candidates having an aggregation level of four and associated with a two port transmission. Here, the MAC-CE activation command may update the initial spatial RRC PDCCH configuration to instead be a one port transmission, with corresponding precoder cycling or another precoder.

In some other cases, the network node 110 may transmit, and the UE 120 may receive, the PDCCH configuration to the UE 120 (e.g., at 410) through DCI (e.g., in PDCCH). For example, the network node 110 may transmit the spatial configuration for the PDCCH configuration using a two transmission DCI with a preemption indication (e.g., similar to a puncturing indication). Additionally, or alternatively, the network node 110 may indicate the PDCCH configuration based on indicating, via the DCI, a DCI format for the PDCCH transmission. In some cases, the DCI format for the PDCCH transmission may be indicative of the MIMO configuration for the set of PDCCH candidates. In some cases, the DCI format may enable fast signaling of DCI ports and a DMRS configuration (e.g., similar to a DCI format 1_1 for PDSCH MIMO transmissions). In some cases, the DCI format may include a spatial configuration if the network node 110 does not communicate the spatial configuration to the UE 120 via RRC signaling or a MAC-CE command. Additionally, or alternatively, the network node 110 may transmit the PDCCH configuration via the DCI if the spatial configuration changes after the network node 110 communicates the spatial configuration to the UE 120 via the RRC signaling or the MAC-CE command (e.g., if the network node 110 transmits an initial configuration for the PDCCH via RRC signaling or the MAC-CE command, and the spatial configuration subsequently changes).

In some other cases, the network node 110 may transmit, and the UE 120 may receive, the PDCCH configuration to the UE 120 (e.g., at 410) implicitly. For example, the network node 110 may configure one or more SU-MIMO PDCCH candidates (e.g., the set of PDCCH candidates) implicitly by a combination of parameters, which may indicate a procedure for the UE 120 to receive the PDCCH transmission.

For example, the network node 110 may implicitly indicate the PDCCH configuration via one or more parameters associated with configuring the search space that corresponds to the set of PDCCH candidates (e.g., via one or more SearchSpace information element parameters). For example, a search space information element may include a parameter indicating an identifier associated with the search space (e.g., a SearchSpaceID parameter), and the identifier or search space index may be indicative that the corresponding PDCCH candidates (e.g., associated with that search space identifier or search space index) is a MIMO PDCCH candidate. That is, some search space identifiers may indicate that the corresponding PDCCH candidates are MIMO PDCCH candidates. For example, if a maximum quantity of layers that may be configured is two, even search space indices may configure single layer candidates (e.g., SISO PDCCH candidates) and odd search space indices may configure multi-layer candidates (e.g., MIMO PDCCH candidates).

In another example, the network node 110 may implicitly indicate the PDCCH configuration via one or more parameters associated with configuring the control resource set associated with the set of PDCCH candidates (e.g., via one or more ControlResourceSet information element parameters). For example, the control resource set information element may include an identifier associated with the control resource set (e.g., a ControlResourceSetID parameter), and some values of the identifier may indicate that the control resource set is configured for SU-MIMO PDCCH candidates. In another example, the control resource set information element may include a parameter associated with a DMRS configuration (e.g., a pdcch-DMRS-ScramblingID), and some values of the parameter may indicate that a DMRS reference signal for SU-MIMO PDCCH candidates is configured, which may in turn indicate, to the UE 120, that the set of PDCCH candidates or SU-MIMO PDCCH candidates for that control resource set.

In another example, the network node 110 may implicitly indicate the PDCCH configuration via one or more other parameters associated with the PDCCH configuration. In some cases, a parameter associated with one or more CCEs (e.g., one or more CCE indices) may be indicative that the set of PDCCH candidates are SU-MIMO PDCCH candidates. For example, a set of CCE indices (e.g., a set of predefined CCE indices) may correspond to a first or last CCE of a MIMO PDCCH candidate, and the indices may dynamically change every slot according to a cell identifier or another parameter. Additionally or alternatively, a parameter associated with a slot index associated with the set of PDCCH candidates may be indicative that the set of PDCCH candidates are SU-MIMO PDCCH candidates. For example, the UE 120 receiving a search space information element (e.g., a SearchSpaces information element) or a control resource set information element (e.g., a ControlResourceSet information element) in a certain slot (e.g., having a certain slot index) may indicate that the PDCCH configuration is for a set of SU-MIMO PDCCH candidates.

At 415, the network node 110 may transmit, and the UE 120 may receive, a PDCCH transmission in accordance with the PDCCH configuration. For example, at 420, the UE 120 may monitor the set of PDCCH candidates (e.g., in accordance with the PDCCH configuration), and may receive the PDCCH transmission based on monitoring the set of PDCCH candidates. In some cases, the PDCCH transmission may be a MIMO PDCCH transmission, and the UE 120 may receive the PDCCH transmission based on monitoring a set of PDCCH candidates that span more than one MIMO layer.

At 425, the UE 120 may decode control information within the PDCCH transmission. That is, the UE 120 may identify the control information within at least one PDCCH candidate of the set of PDCCH candidates based on monitoring the set of PDCCH candidates and receiving the PDCCH transmission. Then, the UE 120 may decode the control information within the at least one PDCCH candidate.

As indicated above, FIG. 4 is provided as an example. Other examples may differ from what is described with respect to FIG. 4.

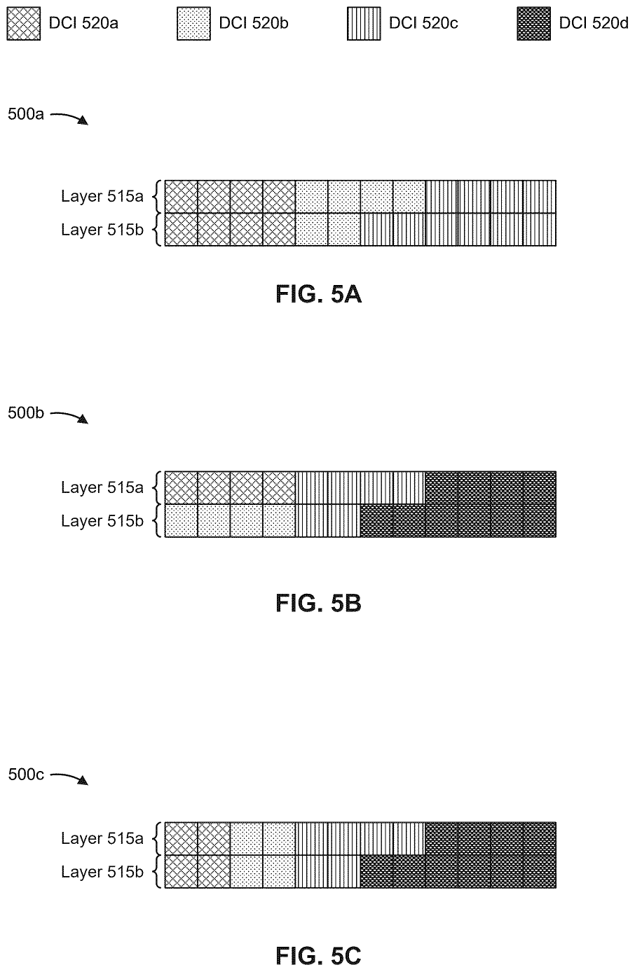

FIGS. 5A, 5B, and 5B are diagrams illustrating example configurations 500 for PDCCH transmissions, in accordance with the present disclosure. In some cases, the configurations 500 may correspond to configurations for sets of PDCCH candidates, including one or more sets of PDCCH candidates associated with SU-MIMO PDCCH transmissions. Each of the configurations 500 may include PDCCH candidates for receiving DCI 520 and are associated with one of two layers 515. The layer 515a may be associated with data streams transmitted via a first transmit antenna of a network node, and the layer 515b may be associated with data streams transmitted via second transmit antenna of the network node. In some cases, both the first and second transmit antennas may be associated with a single TRP. Accordingly, PDCCH transmissions that are transmitted within PDCCH candidates associated with both layers 515 may be SU-MIMO PDCCH transmissions. While the configurations 500 illustrate examples of two-layer PDCCH transmissions, the configurations may also apply to transmissions that include more layers (e.g., three-layer PDCCH transmissions, more than three-layer PDCCH transmissions).

In some cases, a network node may indicate one of the configurations 500 for the SU-MIMO PDCCH transmissions using an RRC parameter. For example, the network node 110 may indicate, to the UE 120, one of the configurations 500 via a SU-MIMO information element (e.g., a SU-MIMO-Mode information element) contained within a search space information element (e.g., a searchSpace information element) or within a control resource set information element (e.g., a ControlResourceSet information element). Each of the configurations 500 may be associated with different benefits in terms of space, time, or frequency diversity, in addition to being associated with an efficient use of available resources.

The configuration 500a may illustrate an example PDCCH configuration for a SU-MIMO PDCCH transmission that carries the DCI 520a. For example, the DCI 520a may be carried in a PDCCH candidate in the layer 515a and the layer 515b. In the example 500a, the PDCCH candidate carrying the DCI 520a may include four CCEs associated with the layer 515a and four CCEs associated with the layer 515b. The configuration 500a may correspond to a space-time-frequency PDCCH configuration. In particular, the network node 110 may perform PHY-layer coding, rate-matching, interleaving, and precoding on the entire set of CCEs within the PDCCH candidate that includes spatial, temporal, and frequency diversity (e.g., includes CCEs in different times, frequencies, and with different spatial configurations). In some cases, performing these procedures on the entire set of CCEs may differ from other procedures (such as those performed by a network node for NR PDCCH transmissions).

The configuration 500b may illustrate an example PDCCH configuration for a SU-MIMO PDCCH transmission that carries the DCI 520a and the DCI 520b. For example, the DCI 520a may be carried in PDCCH candidates in the layer 515a and the DCI 520v may be carried in the PDCCH candidates in the layer 515b. Here, both the DCI 520a and the DCI 520b may be for a same UE 120. In the example 500b, the PDCCH candidates carrying the DCI 520a may include four PDCCH candidates corresponding to the layer 515a and the PDCCH candidates carrying the DCI 520b may include four PDCCH candidates corresponding to the layer 515b. The configuration 500b may correspond to a configuration for spatially multiplexing the PDCCH. That is, M PDCCH candidates may be transmitted using a DCI-per-layer mapping. In the example configuration 500b, M may correspond to two, and the first PDCCH candidate may carry the first DCI 520a and be mapped to the first layer 515a and the second PDCCH candidate may carry the second DCI 520b be mapped to the second layer 515b.

The configuration 500c may illustrate an example PDCCH configuration for a SU-MIMO PDCCH transmission that carries the DCI 520a. For example, the DCI 520a may be carried in a PDCCH candidate that is mapped to the layer 515a and the layer 515b. In the example 500c, the PDCCH candidate carrying the DCI 520a may include two CCEs associated with the layer 515a and two CCEs associated with the layer 515b. The configuration 500c may correspond to a split-DCI configuration, wherein a single PDCCH candidate is transmitted using M layers. In the example 500c, M may be two, and the single PDCCH candidate may be transmitted via the first layer 515a and the second layer 515b and may carry the DCI 520a.

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with PDCCH transmission configurations.

As shown in FIG. 6, in some aspects, process 600 may include receiving a configuration for a PDCCH transmission indicating a set of PDCCH candidates that spans a plurality of MIMO layers associated with a single TRP (block 610). For example, the UE (e.g., using reception component 702 and/or communication manager 706, depicted in FIG. 7) may receive a configuration for a PDCCH transmission indicating a set of PDCCH candidates that spans a plurality of MIMO layers associated with a single TRP, as described above with reference to FIGS. 3 and 4.

As further shown in FIG. 6, in some aspects, process 600 may include monitoring for control information in the set of PDCCH candidates in accordance with the configuration (block 620). For example, the UE (e.g., using communication manager 706, depicted in FIG. 7) may monitor for control information in the set of PDCCH candidates in accordance with the configuration, as described above with reference to FIGS. 3 and 4.

As further shown in FIG. 6, in some aspects, process 600 may include decoding the control information identified within at least one PDCCH candidate of the set of PDCCH candidates (block 630). For example, the UE (e.g., using communication manager 706, depicted in FIG. 7) may decode the control information identified within at least one PDCCH candidate of the set of PDCCH candidates, as described above with reference to FIGS. 3 and 4.

Process 600 may include additional aspects, such as any single aspect or any combination of aspects described below and/or in connection with one or more other processes described elsewhere herein.

In a first aspect, receiving the configuration comprises receiving radio resource control signaling comprising an indication of the configuration for the PDCCH transmission. In a second aspect, alone or in combination with the first aspect, process 600 includes the configuration is associated with a DCI format of the PDCCH transmission, the radio resource control signaling indicates, for PDCCH transmissions having the DCI format, the configuration for the PDCCH transmission via a search space set associated with the PDCCH transmissions, a control resource set associated with the PDCCH transmissions, or both, and the configuration indicates, for the PDCCH transmissions having the DCI format, whether the PDCCH transmission is a MIMO PDCCH transmission or a SISO PDCCH transmission, and a quantity of PDCCH candidates in the set that the UE is to monitor based at least in part on a quantity of MIMO layers in the plurality of MIMO layers.

In a third aspect, alone or in combination with one or more of the first and second aspects, process 600 includes the indication is associated with a MIMO search space set, a MIMO control resource set, or both, and the indication configures the MIMO search space set, the MIMO control resource set, or both to include the set of PDCCH candidates. In a fourth aspect, alone or in combination with one or more of the first through third aspects, process 600 includes a second set of PDCCH candidates associated with a SISO control resource set overlaps at least partially with the set of PDCCH candidates associated with the MIMO control resource set in a frequency domain, or the second set of PDCCH candidates associated with the SISO control resource set does not overlap with the set of PDCCH candidates associated with the MIMO control resource set in the frequency domain.

In a fifth aspect, alone or in combination with one or more of the first through fourth aspects, process 600 includes the configuration is associated with a MIMO DCI format of the PDCCH transmission, and the radio resource control signaling indicates, for PDCCH transmissions having the MIMO DCI format, a quantity of PDCCH candidates in the set that the UE is to monitor based at least in part on a quantity of MIMO layers in the plurality of MIMO layers. In a sixth aspect, alone or in combination with one or more of the first through fifth aspects, process 600 includes the configuration indicates a plurality of CCEs that are associated with MIMO PDCCH candidates, and the set of PDCCH candidates comprises CCEs from the plurality of CCEs that are associated with the MIMO PDCCH candidates. In a seventh aspect, alone or in combination with one or more of the first through sixth aspects, receiving the configuration comprises receiving an activation command indicating the configuration for the PDCCH transmission.

In an eighth aspect, alone or in combination with one or more of the first through seventh aspects, process 600 includes the activation command indicates that the PDCCH transmission has a quantity of MIMO layers included in the plurality of MIMO layers, the activation command indicates, from a set of transmission configuration indicator states that correspond to MIMO transmission configuration indicator states, a transmission configuration indicator state associated with receiving the PDCCH transmission, and the configuration is associated with PDCCH transmissions having the quantity of MIMO layers and the transmission configuration indicator state indicated by the activation command. In a ninth aspect, alone or in combination with one or more of the first through eighth aspects, the activation command further indicates an aggregation level associated with the PDCCH transmission, a puncturing level associated with the PDCCH transmission, or both. In a tenth aspect, alone or in combination with one or more of the first through ninth aspects, process 600 includes receiving control signaling indicating an initial configuration for the PDCCH transmission, wherein the activation command indicates for the configuration for the PDCCH transmission to be updated from the initial configuration. In an eleventh aspect, alone or in combination with one or more of the first through tenth aspects, process 600 includes transmitting signaling indicative of a channel condition associated with the UE, wherein the activation command is responsive to the channel condition. In a twelfth aspect, alone or in combination with one or more of the first through eleventh aspects, the signaling comprises a sounding reference signal, a physical uplink channel feedback indication, or a combination thereof. In a thirteenth aspect, alone or in combination with one or more of the first through twelfth aspects, the activation command comprises a MAC-CE.

In a fourteenth aspect, alone or in combination with one or more of the first through thirteenth aspects, receiving the configuration comprises receiving DCI indicating the configuration for the PDCCH transmission. In a fifteenth aspect, alone or in combination with one or more of the first through fourteenth aspects, process 600 includes the DCI indicates a DCI format for the PDCCH transmission, and the DCI format is indicative of the configuration for the PDCCH transmission. In a sixteenth aspect, alone or in combination with one or more of the first through fifteenth aspects, process 600 includes receiving control signaling indicating an initial configuration for the PDCCH transmission, wherein the DCI indicates for the configuration for the PDCCH transmission to be updated from the initial configuration. In a seventeenth aspect, alone or in combination with one or more of the first through sixteenth aspects, the configuration is indicative of a search space associated with the set of PDCCH candidates, a control resource set associated with the set of PDCCH candidates, the set of PDCCH candidates, or an aggregation level associated with the PDCCH transmission.

In an eighteenth aspect, alone or in combination with one or more of the first through seventeenth aspects, the configuration implicitly indicates that the PDCCH transmission is a MIMO PDCCH transmission associated with a single TRP based at least in part on the search space being associated with MIMO PDCCH transmissions, the control resource set being associated with MIMO PDCCH transmissions, or a slot associated with the PDCCH transmission being associated with MIMO PDCCH transmissions. In a nineteenth aspect, alone or in combination with one or more of the first through eighteenth aspects, the configuration is indicative of a port associated with the PDCCH transmission based at least in part on a mapping between a set of ports and a search space associated with the set of PDCCH candidates. In a twentieth aspect, alone or in combination with one or more of the first through nineteenth aspects, process 600 includes receiving signaling indicative of a port associated with the PDCCH transmission, wherein monitoring for the control information is based at least in part on receiving the signaling. In a twenty-first aspect, alone or in combination with one or more of the first through twentieth aspects, process 600 includes performing one or more blind decoding operations to identify a port and demodulation reference signal configurations associated with the set of PDCCH candidates, wherein decoding the control information is based at least in part on the one or more blind decoding operations.

In a twenty-second aspect, alone or in combination with one or more of the first through twenty-first aspects, the configuration indicates one or more of a precoding type associated with the PDCCH transmission, a quantity of the MIMO layers in the plurality of MIMO layers, or an indication of a plurality of CCEs that correspond to the set of PDCCH candidates.

In a twenty-third aspect, alone or in combination with one or more of the first through twenty-second aspects, the set of PDCCH candidates comprises a first PDCCH candidate that comprises at least one CCE on a first MIMO layer of the plurality of MIMO layers and at least one CCE on a second MIMO layer of the plurality of MIMO layers. In a twenty-fourth aspect, alone or in combination with one or more of the first through twenty-third aspects, the set of PDCCH candidates comprises a first PDCCH candidate comprising one or more CCEs within a first MIMO layer of the plurality of MIMO layers, and a second PDCCH candidate comprising one or more CCEs within a second MIMO layer of the plurality of MIMO layers.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive a configuration for a PDCCH transmission indicating a set of PDCCH candidates that spans a plurality of MIMO layers associated with a single TRP. The communication manager 706 may monitor for control information in the set of PDCCH candidates in accordance with the configuration. The communication manager 706 may decode the control information identified within at least one PDCCH candidate of the set of PDCCH candidates.

The reception component 702 may receive control signaling indicating an initial configuration for the PDCCH transmission, wherein the activation command indicates for the configuration for the PDCCH transmission to be updated from the initial configuration.

The transmission component 704 may transmit signaling indicative of a channel condition associated with the UE, wherein the activation command is responsive to the channel condition.

The reception component 702 may receive control signaling indicating an initial configuration for the PDCCH transmission, wherein the DCI indicates for the configuration for the PDCCH transmission to be updated from the initial configuration.

The reception component 702 may receive signaling indicative of a port associated with the PDCCH transmission, wherein monitoring for the control information is based at least in part on receiving the signaling.

The communication manager 706 may perform one or more blind decoding operations to identify a port and demodulation reference signal configurations associated with the set of PDCCH candidates, wherein decoding the control information is based at least in part on the one or more blind decoding operations.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

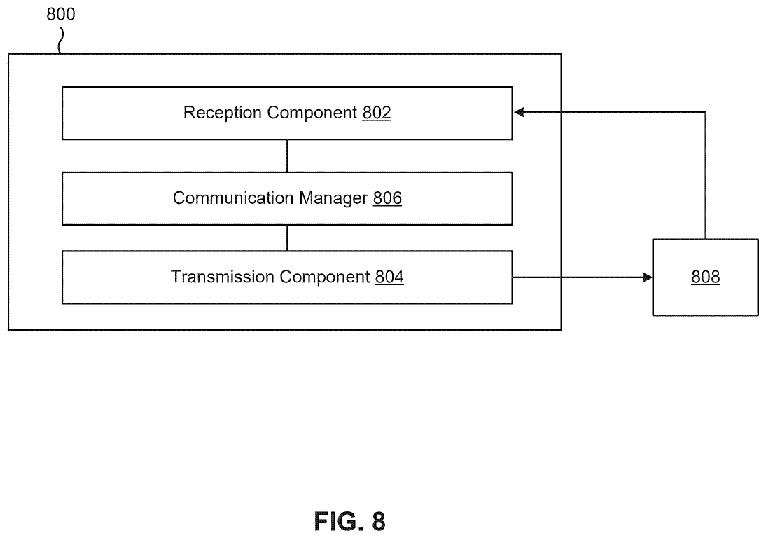

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-5. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit a configuration for a PDCCH transmission indicating a set of PDCCH candidates that spans a plurality of MIMO layers associated with a single TRP. The transmission component 804 may transmit control information in the set of PDCCH candidates in accordance with the configuration.

The transmission component 804 may transmit control signaling indicating an initial configuration for the PDCCH transmission, wherein the activation command indicates for the configuration for the PDCCH transmission to be updated from the initial configuration.

The reception component 802 may receive signaling indicative of a channel condition associated with the UE, wherein the activation command is responsive to the channel condition.

The communication manager 806 may Transmit control signaling indicating an initial configuration for the PDCCH transmission, wherein the DCI indicates for the configuration for the PDCCH transmission to be updated from the initial configuration.

The transmission component 804 may transmit signaling indicative of a port associated with the PDCCH transmission, wherein transmitting the control information is based at least in part on transmitting the signaling.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

### Aspect 1

A method of wireless communication performed by a UE, comprising: receiving a configuration for a PDCCH transmission indicating a set of PDCCH candidates that spans a plurality of MIMO layers associated with a single TRP; monitoring for control information in the set of PDCCH candidates in accordance with the configuration; and decoding the control information identified within at least one PDCCH candidate of the set of PDCCH candidates.

### Aspect 2

The method of Aspect 1, wherein receiving the configuration comprises: receiving radio resource control signaling comprising an indication of the configuration for the PDCCH transmission.

### Aspect 3

The method of Aspect 2, wherein: the configuration is associated with a DCI format of the PDCCH transmission; the radio resource control signaling indicates, for PDCCH transmissions having the DCI format, the configuration for the PDCCH transmission via a search space set associated with the PDCCH transmissions, a control resource set associated with the PDCCH transmissions, or both; and the configuration indicates, for the PDCCH transmissions having the DCI format, whether the PDCCH transmission is a MIMO PDCCH transmission or a SISO PDCCH transmission, and a quantity of PDCCH candidates in the set that the UE is to monitor based at least in part on a quantity of MIMO layers in the plurality of MIMO layers.

### Aspect 4

The method of Aspect 2, wherein: the indication is associated with a MIMO search space set, a MIMO control resource set, or both; and the indication configures the MIMO search space set, the MIMO control resource set, or both to include the set of PDCCH candidates.

### Aspect 5

The method of Aspect 4, wherein: a second set of PDCCH candidates associated with a SISO control resource set overlaps at least partially with the set of PDCCH candidates associated with the MIMO control resource set in a frequency domain; or the second set of PDCCH candidates associated with the SISO control resource set does not overlap with the set of PDCCH candidates associated with the MIMO control resource set in the frequency domain.

### Aspect 6

The method of Aspect 2, wherein: the configuration is associated with a MIMO DCI format of the PDCCH transmission; and the radio resource control signaling indicates, for PDCCH transmissions having the MIMO DCI format, a quantity of PDCCH candidates in the set that the UE is to monitor based at least in part on a quantity of MIMO layers in the plurality of MIMO layers.

### Aspect 7

The method of Aspect 2, wherein: the configuration indicates a plurality of CCEs that are associated with MIMO PDCCH candidates; and the set of PDCCH candidates comprises CCEs from the plurality of CCEs that are associated with the MIMO PDCCH candidates.

### Aspect 8

The method of any of Aspects 1-7, wherein receiving the configuration comprises: receiving an activation command indicating the configuration for the PDCCH transmission.

### Aspect 9

The method of Aspect 8, wherein: the activation command indicates that the PDCCH transmission has a quantity of MIMO layers included in the plurality of MIMO layers; the activation command indicates, from a set of transmission configuration indicator states that correspond to MIMO transmission configuration indicator states, a transmission configuration indicator state associated with receiving the PDCCH transmission; and the configuration is associated with PDCCH transmissions having the quantity of MIMO layers and the transmission configuration indicator state indicated by the activation command.

### Aspect 10

The method of Aspect 9, wherein the activation command further indicates an aggregation level associated with the PDCCH transmission, a puncturing level associated with the PDCCH transmission, or both.

### Aspect 11

The method of Aspect 8, further comprising: receiving control signaling indicating an initial configuration for the PDCCH transmission, wherein the activation command indicates for the configuration for the PDCCH transmission to be updated from the initial configuration.

### Aspect 12

The method of Aspect 8, further comprising: transmitting signaling indicative of a channel condition associated with the UE, wherein the activation command is responsive to the channel condition.

### Aspect 13

The method of Aspect 12, wherein the signaling comprises a sounding reference signal, a physical uplink channel feedback indication, or a combination thereof.

### Aspect 14

The method of Aspect 8, wherein the activation command comprises a MAC-CE.

### Aspect 15

The method of any of Aspects 1-14, wherein receiving the configuration comprises: receiving DCI indicating the configuration for the PDCCH transmission.

### Aspect 16

The method of Aspect 15, wherein: the DCI indicates a DCI format for the PDCCH transmission; and the DCI format is indicative of the configuration for the PDCCH transmission.

### Aspect 17

The method of Aspect 15, further comprising: receiving control signaling indicating an initial configuration for the PDCCH transmission, wherein the DCI indicates for the configuration for the PDCCH transmission to be updated from the initial configuration.

### Aspect 18

The method of any of Aspects 1-17, wherein the configuration is indicative of a search space associated with the set of PDCCH candidates, a control resource set associated with the set of PDCCH candidates, the set of PDCCH candidates, or an aggregation level associated with the PDCCH transmission.

### Aspect 19

The method of Aspect 18, wherein the configuration implicitly indicates that the PDCCH transmission is a MIMO PDCCH transmission associated with a single TRP based at least in part on the search space being associated with MIMO PDCCH transmissions, the control resource set being associated with MIMO PDCCH transmissions, or a slot associated with the PDCCH transmission being associated with MIMO PDCCH transmissions.

### Aspect 20

The method of any of Aspects 1-19, wherein the configuration is indicative of a port associated with the PDCCH transmission based at least in part on a mapping between a set of ports and a search space associated with the set of PDCCH candidates.

### Aspect 21

The method of any of Aspects 1-20, further comprising: receiving signaling indicative of a port associated with the PDCCH transmission, wherein monitoring for the control information is based at least in part on receiving the signaling.

### Aspect 22

The method of any of Aspects 1-21, further comprising: performing one or more blind decoding operations to identify a port and demodulation reference signal configurations associated with the set of PDCCH candidates, wherein decoding the control information is based at least in part on the one or more blind decoding operations.

### Aspect 23

The method of any of Aspects 1-22, wherein the configuration indicates one or more of a precoding type associated with the PDCCH transmission, a quantity of the MIMO layers in the plurality of MIMO layers, or an indication of a plurality of CCEs that correspond to the set of PDCCH candidates.

### Aspect 24

The method of any of Aspects 1-23, wherein the set of PDCCH candidates comprises a first PDCCH candidate that comprises at least one CCE on a first MIMO layer of the plurality of MIMO layers and at least one CCE on a second MIMO layer of the plurality of MIMO layers.

### Aspect 25

The method of any of Aspects 1-24, wherein the set of PDCCH candidates comprises: a first PDCCH candidate comprising one or more CCEs within a first MIMO layer of the plurality of MIMO layers; and a second PDCCH candidate comprising one or more CCEs within a second MIMO layer of the plurality of MIMO layers.

### Aspect 26

An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

### Aspect 27

An apparatus for wireless communication at a device, the apparatus comprising one or more memories and one or more processors coupled to the one or more memories, the one or more processors configured to cause the device to perform the method of one or more of Aspects 1-25.

### Aspect 28

An apparatus for wireless communication, the apparatus comprising at least one means for performing the method of one or more of Aspects 1-25.

### Aspect 29

A non-transitory computer-readable medium storing code for wireless communication, the code comprising instructions executable by one or more processors to perform the method of one or more of Aspects 1-25.

### Aspect 30

A non-transitory computer-readable medium storing a set of instructions for wireless communication, the set of instructions comprising one or more instructions that, when executed by one or more processors of a device, cause the device to perform the method of one or more of Aspects 1-25.

### Aspect 31

A device for wireless communication, the device comprising a processing system that includes one or more processors and one or more memories coupled with the one or more processors, the processing system configured to cause the device to perform the method of one or more of Aspects 1-25.

### Aspect 32

An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration for a physical downlink control channel (PDCCH) transmission indicating a set of PDCCH candidates that spans a plurality of multiple input multiple output (MIMO) layers associated with a single transmission reception point (TRP);
monitor for control information in the set of PDCCH candidates in accordance with the configuration; and
decode the control information identified within at least one PDCCH candidate of the set of PDCCH candidates.

2. The apparatus of claim 1, wherein the one or more processors, to cause the UE to receive the configuration, are configured to cause the UE to:
receive radio resource control signaling comprising an indication of the configuration for the PDCCH transmission.

3. The apparatus of claim 2, wherein:
the configuration is associated with a downlink control information format of the PDCCH transmission;
the radio resource control signaling indicates, for PDCCH transmissions having the downlink control information format, the configuration for the PDCCH transmission via a search space set associated with the PDCCH transmission, a control resource set associated with the PDCCH transmission, or both; and
the configuration indicates, for the PDCCH transmissions having the downlink control information format, whether the PDCCH transmission is a MIMO PDCCH transmission or a single input single output PDCCH transmission, and a quantity of PDCCH candidates in the set that the UE is to monitor based at least in part on a quantity of MIMO layers in the plurality of MIMO layers.

4. The apparatus of claim 2, wherein:
the indication is associated with a MIMO search space set, a MIMO control resource set, or both; and
the indication configures the MIMO search space set, the MIMO control resource set, or both to include the set of PDCCH candidates.

5. The apparatus of claim 4, wherein:
a second set of PDCCH candidates associated with a single input single output control resource set overlaps at least partially with the set of PDCCH candidates associated with the MIMO control resource set in a frequency domain; or
the second set of PDCCH candidates associated with the single input single output control resource set does not overlap with the set of PDCCH candidates associated with the MIMO control resource set in the frequency domain.

6. The apparatus of claim 2, wherein:
the configuration is associated with a MIMO downlink control information format of the PDCCH transmission; and
the radio resource control signaling indicates, for PDCCH transmissions having the MIMO downlink control information format, a quantity of PDCCH candidates in the set that the UE is to monitor based at least in part on a quantity of MIMO layers in the plurality of MIMO layers.

7. The apparatus of claim 2, wherein:
the configuration indicates a plurality of control channel elements (CCEs) that are associated with MIMO PDCCH candidates; and
the set of PDCCH candidates comprises CCEs from the plurality of CCEs that are associated with the MIMO PDCCH candidates.

8. The apparatus of claim 1, wherein the one or more processors, to cause the UE to receive the configuration, are configured to cause the UE to:
receive an activation command indicating the configuration for the PDCCH transmission.

9. The apparatus of claim 8, wherein:
the activation command indicates that the PDCCH transmission has a quantity of MIMO layers included in the plurality of MIMO layers;
the activation command indicates, from a set of transmission configuration indicator states that correspond to MIMO transmission configuration indicator states, a transmission configuration indicator state associated with receiving the PDCCH transmission; and
the configuration is associated with PDCCH transmissions having the quantity of MIMO layers and the transmission configuration indicator state indicated by the activation command.

10. The apparatus of claim 8, wherein the one or more processors are further configured to cause the UE to:
receive control signaling indicating an initial configuration for the PDCCH transmission, wherein the activation command indicates for the configuration for the PDCCH transmission to be updated from the initial configuration.

11. The apparatus of claim 8, wherein the one or more processors are further configured to cause the UE to:
transmit signaling indicative of a channel condition associated with the UE, wherein the activation command is responsive to the channel condition.

12. The apparatus of claim 8, wherein the activation command comprises a media access control control element (MAC-CE).

13. The apparatus of claim 1, wherein the one or more processors, to cause the UE to receive the configuration, are configured to cause the UE to:
receive downlink control information indicating the configuration for the PDCCH transmission.

14. The apparatus of claim 13, wherein:
the downlink control information indicates a downlink control information format for the PDCCH transmission; and
the downlink control information format is indicative of the configuration for the PDCCH transmission.

15. The apparatus of claim 1, wherein the configuration is indicative of a search space associated with the set of PDCCH candidates, a control resource set associated with the set of PDCCH candidates, the set of PDCCH candidates, or an aggregation level associated with the PDCCH transmission.

16. The apparatus of claim 15, wherein the configuration implicitly indicates that the PDCCH transmission is a MIMO PDCCH transmission associated with a single TRP based at least in part on the search space being associated with MIMO PDCCH transmissions, the control resource set being associated with MIMO PDCCH transmissions, or a slot associated with the PDCCH transmission being associated with MIMO PDCCH transmissions.

17. The apparatus of claim 1, wherein the set of PDCCH candidates comprises a first PDCCH candidate that comprises at least one control channel element (CCE) on a first MIMO layer of the plurality of MIMO layers and at least one CCE on a second MIMO layer of the plurality of MIMO layers.

18. The apparatus of claim 1, wherein the set of PDCCH candidates comprises:
a first PDCCH candidate comprising one or more control channel elements (CCEs) within a first MIMO layer of the plurality of MIMO layers; and
a second PDCCH candidate comprising one or more CCEs within a second MIMO layer of the plurality of MIMO layers.

19. A method of wireless communication performed by a user equipment (UE), comprising:
receiving a configuration for a physical downlink control channel (PDCCH) transmission indicating a set of PDCCH candidates that spans a plurality of multiple input multiple output (MIMO) layers associated with a single transmission reception point (TRP);
monitoring for control information in the set of PDCCH candidates in accordance with the configuration; and
decoding the control information identified within at least one PDCCH candidate of the set of PDCCH candidates.

20. A non-transitory computer-readable medium storing a set of instructions for wireless communication, the set of instructions comprising:
one or more instructions that, when executed by one or more processors of a user equipment (UE), cause the UE to:
receive a configuration for a physical downlink control channel (PDCCH) transmission indicating a set of PDCCH candidates that spans a plurality of multiple-input multiple-output (MIMO) layers associated with a single transmission reception point (TRP);
monitor for control information in the set of PDCCH candidates in accordance with the configuration; and
decode the control information identified within at least one PDCCH candidate of the set of PDCCH candidates.
